(19) United States
(12) Patent Application Publication
(10) Pub. No.: US 2001/0048492 A1
(43) Pub. Date: Dec. 6, 2001

(54) Liquid crystal display device and a method thereof

(75) Inventor: Yoshifumi Natsuyama, Yamato-shi (JP)

Correspondence Address: IBM CORPORATION, T.J. WATSON RESEARCH CENTER, P.O. BOX 218, YORKTOWN HEIGHTS, NY, 10598, US

(73) Assignee: IBM

(21) Appl. No.: 09/681,674

(22) Filed: May 18, 2001

(30) Foreign Application Priority Data
May 31, 2000 (JP) 2000-163361

(51) Int. Cl. G02F 1/1333

(52) U.S. Cl. 349/58

(57) ABSTRACT

A display panel having electrode wiring, a circuit board for supplying voltage to electrode wiring, a sheet material for electrically connecting the electrode wiring to circuit board, a frame for holding the display panel, and a restraint member for restraining the circuit board. The sheet material and the frame are restrained from moving relative to each other in a plane direction.

### BACKGROUND OF INVENTION

The present invention relates to a display device and more particularly to a of connecting electrodes in a glass substrate constituting a liquid crystal display panel to a printed circuit board through a TAB (Tape Automated Bonding) tape carrier.

A liquid crystal display has remarkably become widespread as an image display device for a personal computer or other various types of monitors. In general, this of liquid crystal display is configured so as to form an image formed on a liquid surface into a visible image by illuminating the overall liquid crystal surface having a predetermined width with light of uniform brightness emitted from a backlight, i.e., a planar light source for lighting placed at the back of a liquid crystal display panel.

The liquid crystal display comprises a liquid crystal display panel formed of a crystal material sealed in between two glass substrates, a printed circuit board for driving the liquid crystal material mounted on the liquid crystal display panel, a backlight unit placed at the back of the liquid crystal display panel with a liquid crystal display panel holding frame in between and an outer frame for covering the above-mentioned components. Electrodes for driving the liquid crystal material are formed the glass substrates constituting the liquid crystal display panel.

A TAB tape carrier is used as means for connecting the electrodes of the liquid crystal display panel to the printed circuit board. A liquid crystal driver chip is on the TAB tape carrier. FIG. 13 shows a conventional TAB tape carrier 10. The TAB carrier 10 has an insulating film tape 11, input lead conductors 12 and output lead conductors 13 provided on a surface of the insulating film tape 11. The TAB tape 10 also has a chip mounting area 14 for providing a position at which the liquid driver chip is to be mounted. The input lead conductors 12 extend from the chip mounting area 14 toward one edge of the TAB tape carrier 10. The input lead conductors 12 terminate across a narrow long slot 15 formed along the one edge. The output lead conductors 13 extend from the chip mounting area 14 toward the other edge of the TAB tape carrier 10. The liquid crystal driver chip is connected to the input lead conductors 12 and the output lead conductors 13 at the position of the chip mounting area 14.

Thus, a liquid crystal driver tape carrier package is formed. The liquid crystal tape carrier package is mechanically connected between the printed circuit board and the liquid crystal display panel formed of the glass substrates.

It has been pointed out that the liquid crystal driver tape carrier package has the following problem. That is, the problem is that repeated stress is applied to the insulating film tape 11 in the longitudinal direction thereof due to a difference in coefficients of linear expansion between the printed circuit board and the liquid display panel, vibration, warping or deformation of the printed circuit board, or the The repeated stress may cause twists or wrinkles in the insulating film tape 11 and do damage to the input lead conductors 12.

A liquid crystal display device capable of solving the foregoing problem is in Japanese Patent No. 2732553. The liquid crystal display device is characterized in that the TAB tape carrier is fixed to the printed circuit board through at least a pair of anchor holes formed in a region which doesn't have input lead conductor or output conductor and is substantially intensively subjected to thermal stress resulting from difference in the coefficients of linear expansion between the liquid crystal display panel and the printed circuit board. FIGS. 14 and 15 are for illustrating technique disclosed in Japanese Patent No. 2732553. As shown in FIG. 14, the TAB tape carrier disclosed in Japanese Patent No. 2732553 has anchor holes 16 on both sides of the chip mounting area 14 with the chip mounting area 14 between. FIG. 15 is a sectional view showing a state in which the TAB tape carrier 10 is fixed to a printed circuit 17 through the anchor hole 16. The anchor holes 16 are bored through the insulating film tape 11. A solder resist layer 19 is formed on the insulating film tape 11. A substrate pad 20 made of metal is provided on the printed circuit board 17 at the position corresponding to each anchor hole 16. Solder 21 passes through the anchor hole 16 and is anchored to the substrate pad 20 and an anchor pad 18, thereby fixing the TAB tape carrier 10 and the printed circuit board 17. Note that to align the anchor hole 16 with the substrate pad 20, it is effective that the anchor hole 16 and the substrate pad 20 are positioned by pins inserted in through holes provided at the respective positions corresponding to the TAB tape carrier 10 and the printed circuit board 17.

According to the liquid crystal display device disclosed in Japanese Patent No. 2732553, the TAB tape carrier 10 is fixed to the printed circuit board 17 through the anchor holes 16. Thus, it is possible to restrain twists or wrinkles from occurring in TAB tape carrier 10. Therefore, a break in the input lead conductors 12 can be prevented.

However, the liquid crystal display device disclosed in Japanese Patent No. may cause a break in the input lead conductors 12 of the TAB tape carrier 10 under load of increased thermal or mechanical shock.

### SUMMARY OF INVENTION

It is therefore an object of the invention to provide a liquid crystal display device capable of preventing a break in the input lead conductors 12 of the TAB tape carrier even under the load of increased thermal or mechanical shock.

A feature of the present invention includes a display panel having electrode a circuit board for supplying voltage to the electrode wiring, a sheet material for electrically connecting the electrode wiring to the circuit board, a frame for holding display panel, and a restraint member for restraining the circuit board. The sheet material and the frame are restrained from moving relative to each other in the plane direction.

As a more specific feature of the display device of the present invention, there is provided a liquid crystal display that includes a pair of glass substrates facing each other, each having electrodes for applying voltage to a liquid crystal material on a facing surface. Further included is a circuit board for supplying the voltage, and a crystal driver tape carrier package for connecting the electrodes of the glass to the circuit board and mounting a liquid crystal driver chip. The liquid crystal driver tape carrier package and the circuit board have anchor holes respectively, and anchor pins are inserted into the anchor holes, whereby the liquid crystal driver tape carrier package is fixed to the circuit board.

The present invention further includes a method of manufacturing a liquid crystal display device for obtaining the above-described liquid crystal display device. That is, method of manufacturing a liquid crystal display comprising glass substrates having electrodes for driving a liquid crystal material, a circuit board, and a sheet material having a conducting path, the glass substrates being conductively connected to the circuit board through the sheet material, comprises: a first step of mounting the sheet material having through holes in a predetermined region to the glass substrates; a second step of positioning the circuit board having through holes at positions corresponding to the through holes of the sheet material so as to align the through holes of the circuit board with the through holes of the sheet material; a third step of restraining the sheet material and the circuit board from moving at least in the plane direction through the through holes of the sheet material and the through holes of the circuit board, thereby fixing the sheet material and the circuit board; and a fourth step of restraining the sheet material and the circuit board from moving relative to a frame for holding the glass substrates at least in the plane direction through the through holes of the sheet material and the circuit board, thereby fixing the sheet material and the circuit board.

According to yet another feature of the present invention, there is provided a method of connecting a display panel to a circuit board in a display device comprising the display panel having electrode wiring, a frame for holding the display panel and circuit board, comprising the steps of connecting the display panel to the circuit board through a sheet material having a conducting path, and restraining the sheet material and the circuit board from moving relative to the frame in the plane direction.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

For a more complete understanding of the present invention and the advantages thereof, reference is now made to the following description taken in conjunction with the accompanying drawings.

FIG. 1 is an exploded perspective view of a liquid crystal display device 50 to an embodiment of the present invention.

FIG. 2 is an illustration of the assembled liquid crystal display device 50 according to the embodiment of the present invention.

FIG. 3 is a plan view of a TAB tape carrier 10 for use in the liquid crystal display device 50 according to the embodiment of the present invention.

FIG. 4 is an illustration for describing a process of a step of assembling the liquid crystal display device 50 according to the embodiment of the present invention.

FIG. 5 is an illustration for describing the process of the step of assembling the liquid crystal display device 50 according to the embodiment of the present invention.

FIG. 6 is an illustration for describing the process of the step of assembling the liquid crystal display device 50 according to the embodiment of the present invention.

FIG. 7 is an illustration for describing the process of the step of assembling the liquid crystal display device 50 according to the embodiment of the present invention.

FIG. 8 is an illustration for describing the process of the step of assembling the liquid crystal display device 50 according to the embodiment of the present invention.

FIG. 9 is a partially sectional view of a driving circuit 43 (44) of the liquid crystal display device 50 according to the embodiment of the present invention.

FIG. 10 is a partially sectional view of the driving circuit 43 (44) of the liquid display device 50 according to another embodiment of the present invention.

FIG. 11 is a partially sectional view of the driving circuit 43 (44) of the liquid display device 50 according to still another embodiment of the present invention.

FIG. 12 is a partially sectional view of the driving circuit 43 (44) of the liquid display device 50 according to a further embodiment of the present invention.

FIG. 13 is a plan view of a conventional TAB tape carrier 10.

FIG. 14 is a conventional plan view of the TAB tape carrier 10 of a liquid crystal display device.

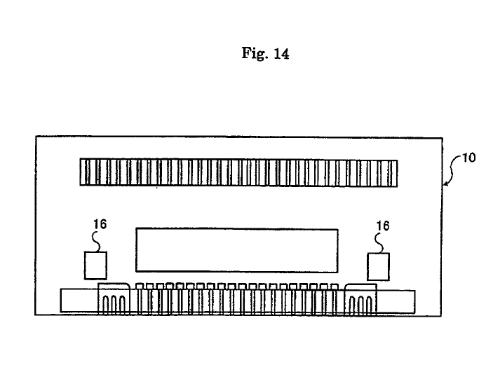

FIG. 15 is a sectional view of a portion near an anchor hole 16 of the liquid crystal display device.

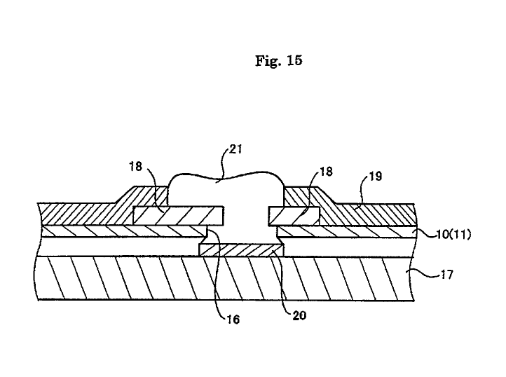

### DETAILED DESCRIPTION

As described above, the liquid crystal display device disclosed in Japanese Patent No. 2732553 has a configuration in which the TAB tape carrier 10 is fixed to the circuit board 17 through the anchor holes 16 formed in a specified region. However, some cases, the above-mentioned fixing method may be insufficient. Therefore, the inventors has paid attention to an approach of fixing the TAB tape carrier 10 and the printed circuit board 17 to the frame for holding the liquid crystal display panel in the liquid crystal display device. When the TAB tape carrier 10 and the printed circuit 17 are fixed to the frame, whereby the TAB tape carrier 10 and the printed circuit 17 are restrained from moving in the plane direction. Therefore, little twist, wrinkle or the like occurs in the TAB tape carrier 10 even under the load of thermal or shock. The present invention is designed based on the above-mentioned findings.

Desirably, the restraint member is located in a path region of substantial propagation of stress resulting from a difference in coefficients of linear expansion between glass substrates constituting the display panel and the circuit board. The restraint member also can have a function of determining the relative positions of the circuit board, the sheet material and the frame.

Desirably, the liquid crystal display further comprises a frame for allowing the anchor pins to stand in a surface holding the pair of glass substrates, wherein the crystal driver tape carrier package and the circuit board are fixed to the frame. In this case, the anchor pins function as the restraint members for restraining the circuit and the sheet material from moving relative to the frame in the plane direction.

In the above-mentioned liquid crystal display device, a pair of the anchor holes located with the liquid crystal driver chip between. The position of each anchor hole is included in a path region of substantial propagation of stress resulting from a difference in coefficients of linear expansion between glass substrates constituting liquid crystal display panel and the circuit board.

In the liquid crystal display device, a grounding conductor may be formed on the frame, and the anchor pins can be made of a conductive material such as metal. And hence a position at which the grounding conductor is to be formed is selected so that the anchor pins may be conductively connected to the grounding conductor, whereby grounding can be ensured without particular work.

Moreover, in the liquid crystal display device, the liquid crystal driver tape carrier package may be soldered to the circuit board through the anchor pins.

The restraining of third step can be realized by inserting pins into the through of the sheet material and the through holes of the circuit board. The through holes correspond to the anchor holes, and the pins correspond to the anchor pins. The restraining of the fourth step can be realized by inserting the pins into pin holding holes of the frame.

In the method of manufacturing a liquid crystal display device of the present invention, an outer periphery of each of the pins is previously plated with solder, the pins are inserted into the through holes of the sheet material and the through holes of the circuit board, and then the sheet material can be soldered to the circuit board by heating the pins. This approach can contribute to a simplified manufacturing process.

In the connecting method described above, pins standing on the frame are into the through holes formed in predetermined regions of the sheet material and the circuit board, whereby the sheet material and the circuit board are restrained from moving. Desirably, the predetermined region is a path region of substantial of stress resulting from a difference in coefficients of linear expansion between glass substrates constituting the display panel and the circuit board.

Embodiments of the present invention will be described below by referring to a liquid crystal display.

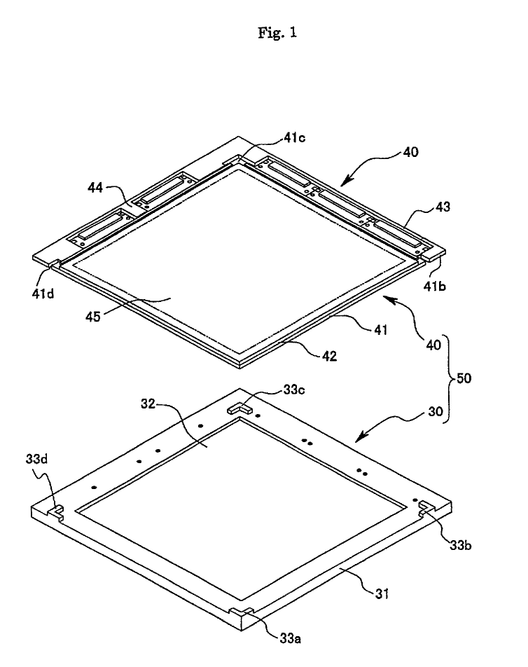

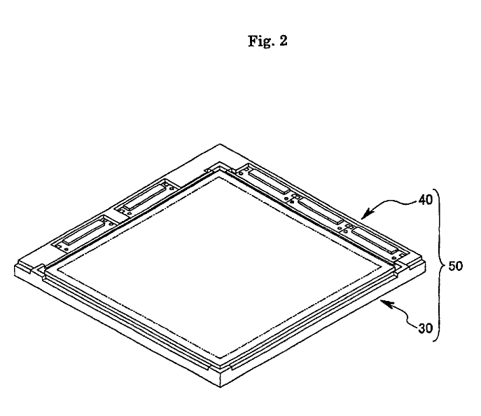

FIGS. 1 and 2 show an embodiment in which the present invention is applied to the liquid crystal display device. A liquid crystal display device 50 according to the embodiment comprises a holding frame 30 and a liquid crystal display panel 40. FIG. is an exploded perspective view of the liquid crystal display device 50. FIG. 2 shows a state of an assembly of the liquid crystal display panel 40 and the holding frame 30.

The holding frame 30 has a box-shaped frame body 31 having an opening 32 having substantially the same size as the size of a display region 45 of the liquid display panel 40. Stoppers 33a, 33b, 33c and 33d for holding the liquid crystal display panel 40 are provided in four corners of the frame body 31. The holding frame 30 is injection molded in one piece of plastic such as polycarbonate or ABS resin.

The liquid crystal display panel 40 has a laminated structure comprising a first substrate 41 and a second glass substrate 42 having a surface area smaller than the surface area of the first glass substrate 41. The first glass substrate 41 and the glass substrate 42 face each other with a predetermined clearance therebetween, and liquid crystal material is sealed in the clearance. Electrodes for driving the liquid material are formed on the respective surfaces of the first glass substrate 41 and the second glass substrate 42 facing the clearance. Driving circuits 43 and 44 for driving the liquid crystal material are formed on the first glass substrate 41 along two sides of the first glass substrate 41.

Since the area of a portion on the first glass substrate 41 except the driving 43 and 44 is substantially equal to the area of the second glass substrate 42, the driving circuits 43 and 44 are exposed to the outside when the first glass substrate 41 and the second glass substrate 42 are laminated to each other. A TAB tape carrier 10 functioning as a sheet material and a printed circuit board 17 are arranged in each of the driving circuits 43 and 44. On the other hand, the display region 45 (a region surrounded by a chain double-dashed line in FIG. 1) is formed in an overlapping of the first glass substrate 41 and the second glass substrate 42.

In the first glass substrate 41, formed are notches 41b, 41c and 41d for engaging the stoppers 33b, 33c and 33d of the holding frame 30 thereinto at the time of assembly of the liquid crystal display panel 40 and the holding frame 30. Note that notches 41b and 41d are rectangular notches, and the notch 41c is an L-shaped

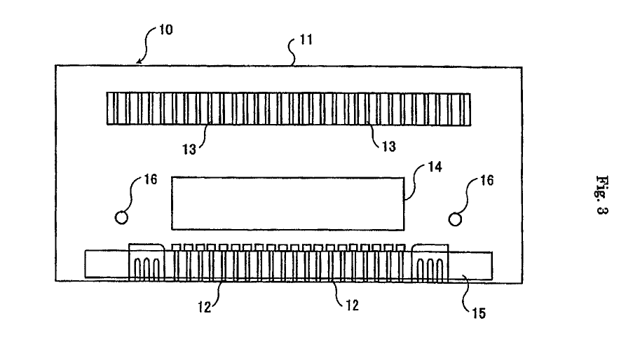

The liquid crystal display device 50 according to the embodiment is characterized by the structures of the driving circuits 43 and 44. The structures of the driving 43 and 44 and a process of manufacturing the driving circuits 43 and 44 will be described below with reference to FIGS. 3 to 9.

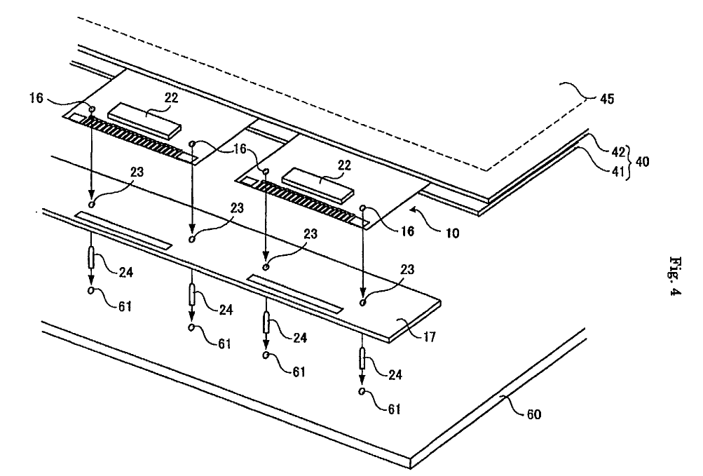

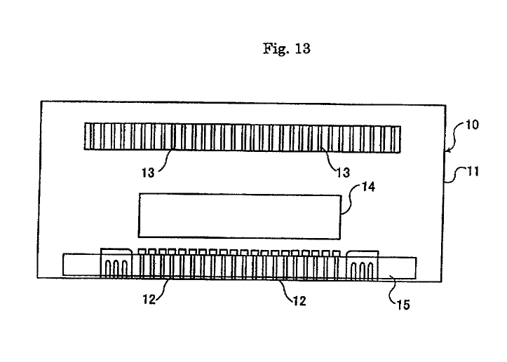

FIG. 3 is a plan view of the TAB tape carrier 10 according to the embodiment. A basic configuration of the TAB tape carrier 10 according to the embodiment is the as that of a conventional TAB tape carrier 10 shown in FIG. 13. That is, the TAB tape carrier 10 has an insulating film tape 11, input lead conductors 12 and output lead conductors 13 provided on a surface of the insulating film tape 11. The TAB tape 10 also has a chip mounting area 14 for providing a position at which a liquid crystal driver chip 22 shown in FIG. 4 is to be mounted. The input lead conductors 12 extend from near the chip mounting area 14 toward one edge of the TAB tape carrier 10. The input lead conductors 12 terminate across a narrow long slot 15 formed along the one edge. The output lead conductors 13 extend from near the chip mounting area 14 toward the other edge of the TAB tape carrier 10. The liquid crystal driver chip 22 is connected to the input lead conductors 12 and the output lead conductors 13 at the position of the chip mounting area 14. In the TAB tape carrier 10 according to the embodiment, a pair of anchor holes 16 is formed with the chip mounting area 14 between. The anchor holes 16 are through holes. The anchor holes 16 are located in a path region of substantial propagation of stress resulting from a difference in coefficients of linear expansion between the first and second glass substrates 41 and 42 constituting the liquid crystal display panel 40 and the printed circuit board 17. path region is located in a region not having the input lead conductors 12 or the lead conductors 13, as described in Japanese Patent No. 2732553.

FIGS. 4 to 8 illustrate the process of manufacturing the liquid crystal display device 50 according to the embodiment.

FIG. 4 shows a state before connecting the TAB tape carrier 10 to the printed board 17. As shown in FIG. 4, the TAB tape carrier 10 mounting the liquid crystal chip 22, i.e., a liquid crystal driver tape carrier package is mounted on the first glass substrate 41. Moreover in the printed circuit board 17, anchor holes 23 that are through holes are formed at the positions corresponding to the anchor holes 16 of the TAB tape carrier 10. An opening diameter of the anchor hole 16 is equal to that of the anchor hole 23.

Reference numeral 60 denotes a jig for holding anchor pins 24. In the jig 60, formed are holding holes 61 for allowing the anchor pins 24 to stand at the positions corresponding to the anchor holes 16 of the TAB tape carrier 10 and the anchor holes 23 of the printed circuit board 17. Each of the holding holes 61 has a bottom and has such a diameter that the anchor pin 24 can be easily inserted into and removed from the holding hole 61.

As shown in FIG. 4, first, the anchor pins 24 are inserted into the holding holes 61 so that the anchor pins 24 are allowed to stand in the jig 60. An outer diameter of the anchor pin 24 is set to such a value that the anchor pin 24 can be press-fitted into the anchor hole 16 of the TAB tape carrier 10 and the anchor hole 23 of the printed circuit board 17.

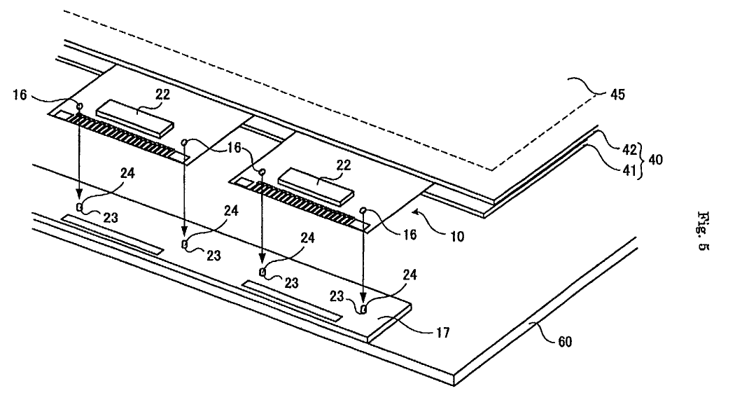

Then, as shown in FIG. 5, the printed circuit board 17 is placed on the jig 60 so the standing anchor pins 24 may be inserted into the anchor holes 23 of the printed circuit board 17. Thus, the anchor pins 24 are press-fitted into the anchor holes 23.

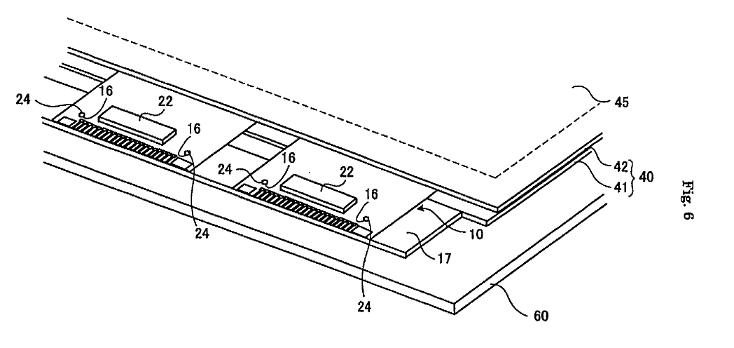

Furthermore, as shown in FIG. 6, the liquid crystal display panel 40 is placed on jig 60 so that the anchor pins 24 may be inserted into the anchor holes 16 of the TAB tape carrier 10. Thus, the anchor pins 24 are press-fitted into the anchor holes 16.

In the above-described manner, the anchor pins 24 pass through the anchor holes 23 of the printed circuit board 17 and the anchor holes 16 of the TAB tape carrier 10. Consequently, the printed circuit board 17 and the TAB tape carrier 10 are fixed via anchor holes 16 and 23 and the anchor pins 24. Moreover, the printed circuit board and the TAB tape carrier 10 are restrained from moving in the plane direction.

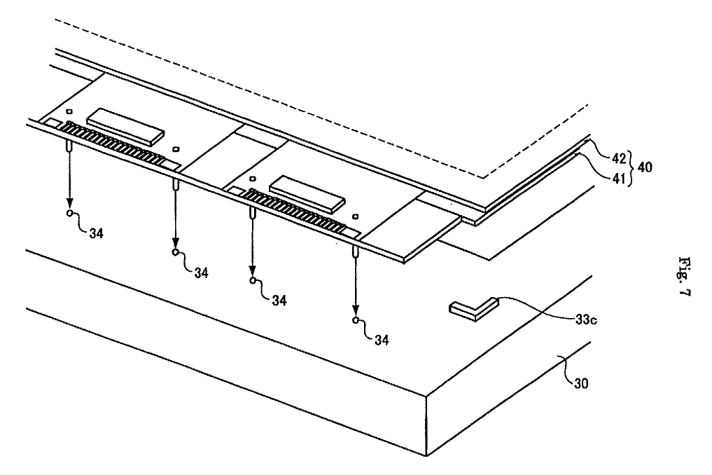

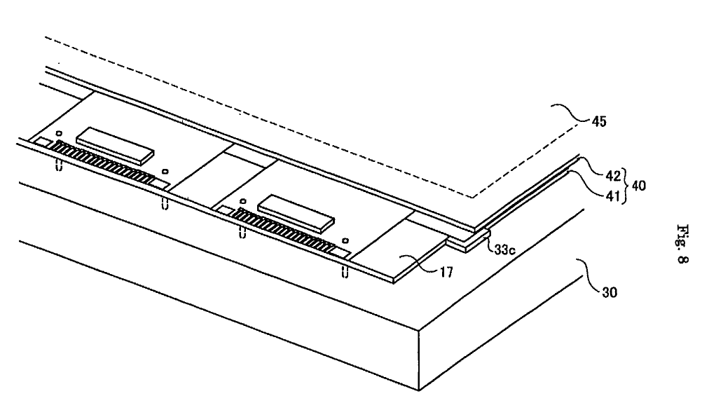

After mounting the liquid crystal display panel 40, the printed circuit board 17 is removed from the jig 60. The anchor pins 24 protrude through a lower surface of the printed circuit board 17. The liquid crystal display panel 40 removed from the jig 60 is placed on the holding frame 30 prepared separately. The process is shown in FIGS. 7 and 8. As shown in FIG. 7, the holding frame 30 has holding holes 34 for inserting the anchor pins 24 thereinto and holding the anchor pins 24. The holding holes 34 are formed at the positions corresponding to the positions of the anchor pins 24. To change a state shown in FIG. 7 to a state shown in FIG. 8, the anchor pins 24 through the lower surface of the printed circuit board 17 are inserted into the holding holes 34 of the holding frame 30. In this state, the corner of the liquid crystal display panel 40 is held by the stopper 33c. Therefore, the liquid crystal display panel 40 is restrained from moving relative to the holding frame 30 in the plane direction. Moreover, an end of the printed circuit board 17 (the right end in FIGS. 7 and 8) is designed so as to collide with the stopper 33c of the holding frame 30.

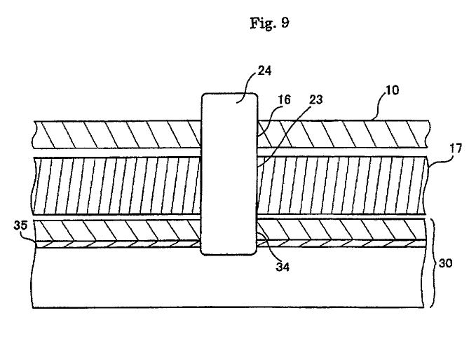

FIG. 9 shows a cross sectional view of the liquid crystal display 50 according to the embodiment, specifically a portion near the anchor pin 24. As shown in FIG. 9, the anchor pin 24 passes through the anchor hole 16 of the TAB tape carrier 10 and the anchor hole 23 of the printed circuit board 17. A lower end of the anchor pin 24 is inserted into the holding hole 34 of the holding frame 30. Therefore, the TAB tape carrier 10 and the printed circuit board 17 are restrained from moving relative to the holding frame 30 in the plane direction. The anchor pin 24 functions as a restraint member for restraining the TAB tape carrier 10 and the printed circuit board 17 from moving relative to the holding frame 30 in the plane direction. The anchor pin 24 may be fixed in the holding hole 34 or be removable from the holding hole 34.

According to the embodiment, the anchor pins 24 are located in the path region substantial propagation of stress resulting from the difference in the coefficients of linear expansion between the first and second glass substrates 41 and 42 constituting the liquid crystal display panel 40 and the printed circuit board 17. Therefore, the propagation of stress can be prevented, and thus a break in the input lead conductors 12 can be prevented. The anchor pins 24 are also effective against a break in the lead conductors 12 due to vibration or shock applied to the liquid crystal display 50. More particularly, according to the embodiment, the anchor pins 24 are inserted the holding holes 34 of the holding frame 30. Therefore, the TAB tape carrier 10 and the printed circuit board 17 are restrained from moving relative to the holding frame in the plane direction. Accordingly, the liquid crystal display device 50 is more to the difference in the coefficients of linear expansion, vibration or shock.

Furthermore, as mentioned above, the end of the printed circuit board 17 (the end in FIGS. 7 and 8) is designed so as to collide with the stopper 33c of the holding frame 30. Although the stopper 33c is originally provided for the purpose of holding the liquid crystal display panel 40, the stopper 33c also has a function of restraining printed circuit board 17 from moving.

Furthermore, in the embodiment, as shown in FIG. 9, a grounding conductor 35 is formed on the lower surface of the holding frame 30. The grounding conductor 35 is conductively connected to the anchor pins 24. In other words, the embodiment has an advantage of being able to automatically provide conductive connection between the anchor pins 24 and the grounding conductor 35 by assembling the liquid crystal device 50.

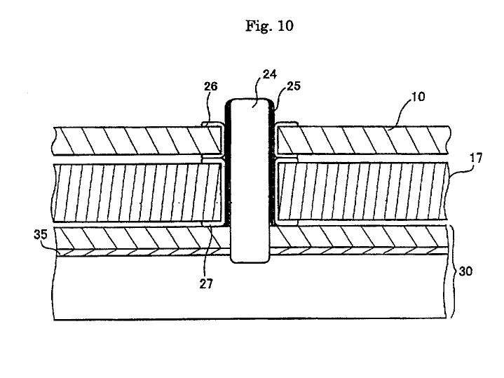

In the above-described embodiment, the TAB tape carrier 10 is fixed to the circuit board 17 by press-fitting the anchor pins 24 into the anchor holes. However, present invention is not limited to the above-described embodiment. For example, the TAB tape carrier 10 may be fixed to the printed circuit board 17 by means of solder An example will be described with reference to FIG. 10.

FIG. 10 is a sectional view of a portion near the anchor pin 24 in the example in which the TAB tape carrier 10 is fixed to the printed circuit board 17 by means of the solder 25. In the example, an outer peripheral surface of the anchor pin 24 to be inserted into the TAB tape carrier 10 and the printed circuit board 17 is previously plated with the solder 25. Moreover, a metallic tube 26 and a metallic tube 27 are located in the anchor hole 16 of the TAB tape carrier 10 and the anchor hole 23 of the printed circuit board 17, respectively. After the anchor pin 24 is inserted into the anchor holes 16 and 23, the anchor pin 24 is heated. Heating allows the solder 25 to melt. After heating is stopped, the solder 25 solidifies. Thus, the TAB tape carrier 10 can be fixed to the printed circuit board 17 by means of the anchor pin 24 and the solder 25. The solder may be replaced with an adhesive.

Although the anchor pin 24 is used in the above-described embodiment, the present invention is not limited to the embodiment. For example, a member corresponding to the anchor pin 24 may be integrally formed with the printed circuit board 17 or the holding frame 30.

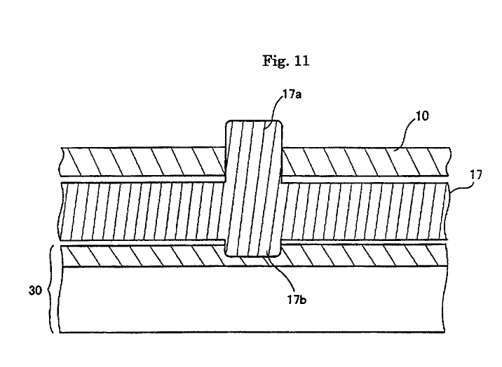

FIG. 11 is a sectional view showing an example in which the members corresponding to the anchor pin 24 are provided in the printed circuit board 17. As shown in FIG. 11, in the example, anchors 17a and 17b are formed on front and rear surfaces of the printed circuit board 17, respectively. The anchors 17a and 17b are integrally formed with the printed circuit board 17. The anchor 17a is inserted into the anchor hole 16 of the TAB tape carrier 10, and the anchor 17b is inserted into the holding hole 34 of the holding frame 30. Therefore, the anchors 17a and 17b function as the restraint members for restraining the TAB tape carrier 10 and the printed circuit board 17 from moving relative to the holding frame 30 in the plane direction. Note various fixing means such as press fitting, the solder or the adhesive described above can be used to fix the anchor 17a to the TAB tape carrier 10 or to fix the anchor 17b the holding frame 30.

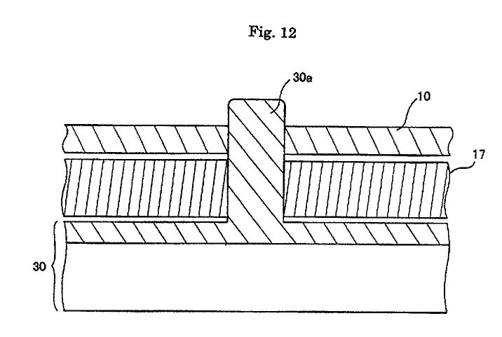

FIG. 12 is a sectional view showing an example in which the member to the anchor pin 24 is provided in the holding frame 30. As shown in FIG. 12, in the example, an anchor 30a is formed on the front surface of the holding frame 30. The anchor 30a is integrally formed with the holding frame 30. The anchor 30a is inserted into the anchor hole 16 of the TAB tape carrier 10 and the anchor hole 23 of the circuit board 17. Therefore, the anchor 30a functions as the restraint member for restraining the TAB tape carrier 10 and the printed circuit board 17 from moving relative to the holding frame 30 in the plane direction. Similarly to the above-mentioned example, various fixing means such as press fitting, the solder or the adhesive can be used to fix the anchor 30a to the TAB tape carrier 10 and the printed circuit board 17.

Although the embodiments of the present invention have been described above by referring to the liquid crystal display device, the present invention can be applied to only the liquid crystal display device but also other display devices. Examples of other display devices include a self light emitting type display using a PLED (polymer light emitting diode) controlling light emission by controlling voltage to be applied to a polymeric organic film, or an OLED (organic light emitting diode), and so on.

As described above, according to the present invention, there is provided a liquid crystal display device capable of preventing a break in lead conductors even under the load of increased thermal or mechanical shock.

Although the preferred embodiments of the present invention have been in detail, it should be understood that various changes, substitutions and alternations can be made therein without departing from spirit and scope of the inventions as defined by the appended claims.

1. A display device comprising:
a display panel having electrode wiring;
a circuit board for supplying voltage to said electrode wiring;
a sheet material for electrically connecting said electrode wiring to said circuit board;
a frame for holding said display panel; and
a restraint member for restraining said circuit board, said sheet material and frame from moving relatively from one to another in a plane direction.

2. The display device according to claim 1, wherein said restraint member is located in a path region of substantial propagation of stress resulting from a difference in coefficients of linear expansion between glass substrates constituting said display panel and said circuit board.

3. The display device according to claim 1, wherein said restraint member has a function of determining the relative positions of said circuit board, said sheet material and said frame.

4. A liquid crystal display device comprising:
a pair of glass substrates facing each other, each having electrodes for applying voltage to a liquid crystal material on a facing surface;
a circuit board for supplying said voltage; and
a liquid crystal driver tape carrier package for connecting said electrodes of said glass substrates to said circuit board and mounting a liquid crystal driver chip, wherein said liquid crystal driver tape carrier package and said circuit board anchor holes, and
anchor pins are inserted into said anchor holes, whereby said liquid crystal tape carrier package is fixed to said circuit board.

5. The liquid crystal display device according to claim 4 further comprising a frame for allowing said anchor pins to stand on a surface holding said pair of glass substrates, wherein said liquid crystal driver tape carrier package and said circuit board are fixed to said frame.

6. The liquid crystal display device according to claim 4, wherein a pair of said anchor holes is located with said liquid crystal driver chip between.

7. The liquid crystal display device according to claim 5, wherein a grounding conductor is formed on said frame, and said conductive anchor pins are conductively connected to said grounding conductor.

8. The liquid crystal display device according to claim 4, wherein said liquid crystal driver tape carrier package is soldered to said circuit board via said pins.

9. A method of manufacturing a liquid crystal display device comprising glass substrates having electrodes wired for driving a liquid crystal material, a circuit board, and a sheet material having a conducting path, said glass substrates conductively connected to said circuit board through said sheet material, said method comprising the steps of:
mounting said sheet material having through holes in a predetermined region said glass substrates;
positioning said circuit board having through holes at positions corresponding the through holes of said sheet material so as to align the through holes of said circuit board with the through holes of said sheet material;
restraining said sheet material and said circuit board from moving at least in a plane direction through the through holes of said sheet material and the holes of said circuit board, thereby fixing said sheet material and said circuit board; and
restraining said sheet material and said circuit board from moving relative to a frame for holding said glass substrates at least in the plane direction through through holes of said sheet material and said circuit board, thereby fixing said sheet material and said circuit board.

10. The method of manufacturing a liquid crystal display device according to claim 9, wherein said restraining step further includes the step of inserting pins into the through holes of said sheet material and the through holes of said board.

11. The method of manufacturing a liquid crystal display device according to claim 10, wherein said restraining step further includes the step of inserting pins into pin holding holes of said frame.

12. The method of manufacturing a liquid crystal display device according to claim 9, further includes the steps of providing an outer periphery of each of pins with solder, inserting said pins into the through holes of said sheet and the through holes of said circuit board, and soldering said sheet material to said circuit board by heating said pins.

13. A method of connecting a display panel to a circuit board in a display device comprising said display panel having electrode wiring, a frame for holding said display panel and said circuit board, comprising the steps of:
connecting said display panel to said circuit board through a sheet material having a conducting path, and
restraining said sheet material and said circuit board from moving relative to frame in a plane direction.

14. The connecting method according to claim 13, wherein said restraining step further includes the step of inserting pins standing in said frame into through holes formed in predetermined regions of said sheet material and said circuit board, whereby said sheet material and said circuit board are restrained from moving.

15. The connecting method according to claim 14, further includes the step of defining said predetermined region as a path region of substantial propagation stress resulting from a difference in coefficients of linear expansion between glass substrates constituting said display panel and said circuit board.
